(19) United States
(12) Patent Application Publication
(10) Pub. No.: US 2017/0240249 A1
(43) Pub. Date: Aug. 24, 2017

(54) BEARING ASSEMBLY FOR AN AXIALLY LOADED MEMBER

(71) Applicant: SUBSEA RISER PRODUCTS LIMITED, Woking Surrey (GB)

(72) Inventor: John SHIELD, London (GB)

(73) Assignee: SUBSEA RISER PRODUCTS LIMITED, Woking Surrey (GB)

(21) Appl. No.: 15/511,942

(22) PCT Filed: Sep. 17, 2015
(86) PCT No.: PCT/EP2015/071385

§ 371 Date: Mar. 16, 2017

(30) Foreign Application Priority Data
Sep. 18, 2014 (GB) 1416532.8

(51) Int. Cl. B63B 21/24; F16C 11/08; F16C 27/06

(52) U.S. Cl. CPC B63B 21/24; F16C 27/063; F16C 11/083; F16C 2350/00

(57) ABSTRACT

The present invention relates to a system used in the offshore renewables or oil and gas industries for providing articulation at the end of a mooring line or a riser. The design uses a nested rubber segment (14) and orthogonal cylindrical bearings (12) to provide articulation with low resistance at both small and large oscillation angles. A relative rotational force applied between the axially loaded member (1) and the anchor assembly (4) causes the angle of the axially loaded member (1) to change to reduce such forces. The securement assembly comprises a bearing assembly (10) arranged to provide rotation about a pin (11). The bearing assembly (10) is arranged to provide two distinct stages for relative rotation. In the first stage, small relative rotations are accommodated by the flexion or deformation in the rubber layer (14). This deformation of the rubber layer (14) enables the axially loaded member (1) to rotate around the pin (11) and move relative to the anchor assembly (4). In the second stage, the further and subsequent movement of the axially loaded member (1) causes an articulating surface to physically slide over the bearing surface.

### FIELD OF THE INVENTION

The present invention relates to a bearing assembly for an axially loaded member, securement apparatus for an axially loaded member and to a method of securing an axially loaded member. In particular, the present invention relates to a subsea bearing assembly, subsea securement apparatus for an axially loaded member and to a method of securing an axially loaded member subsea.

More specifically, the present invention relates to a structural interface used on a floating vessel for supporting axially loaded members subject to variable environmental loading. Such interface is typically used in the offshore oil and gas industry; for connection of catenary mooring lines, vertical mooring tethers and risers used in the transmission of drilling and production fluids.

### BACKGROUND TO THE INVENTION

Floating offshore production facilities are typically moored to the seabed via mooring lines or tethers to maintain the vessel's required position with respect to the seabed. Such floating production systems also use risers, which are tubular structures, to convey high pressure oil or gas to or from a well on the seabed.

Langner (U.S. Pat. No. 5,269,629) describes a method for supporting steel catenary risers from a floating vessel, by providing an elastomeric pressure containing flexible joint at the interface between the riser and vessel. The interface is referred to as a hangoff point or riser porch. The elastomeric element bears the high axial loads required to support the riser whilst its construction and material selection allows angular deflections at relatively small bending stiffness. This gives the ability to accommodate variations in riser approach angle relative to the vessel that result from vessel motions and changes in riser geometry.

Riggs et al (U.S. Pat. No. 5,951,061) further describe a development of the elastomeric flex joint mechanism in detail and propose the incorporation of a swivel bearing to accommodate vessel yaw.

In these systems the elastomeric flex joint mechanism provides low angular stiffness and is provided to limit the stresses in the riser components and thus improve the fatigue life of the hangoff and adjoining riser joints. Hence it is evident that the rotational stiffness of the flex element is an important factor to achieving the required extreme stress and fatigue performance of the riser system.

Mooring lines and tethers to floating vessels or buoyant submerged structures feature similar design challenges to risers. The connection points are also subject to high tension and must accommodate relative angular motions between the mooring line and vessel in response to loading from ocean currents, waves and wind.

If the mooring lines or tethers are subject to a high mean tension, the dominant mode of failure is fatigue damage at the point of connection to the vessel, owing to large local bending fluctuations. Where such mooring lines and tethers are constructed from chain, such failures are due to out-of-plane bending fatigue damage to the links—particularly the last restrained link.

Lange (U.S. Pat. No. 5,441,008) describes a method for articulating a fairlead and subsea chain stopper in a subsea mooring hangoff. The design makes use of bearings with low friction and a long tube (or hawsepipe) to allow the chain termination point to rotate freely to accommodate relative angular motion that occurs between the vessel and mooring chains. However, even with such fairlead devices it is typical that mooring chain fatigue at the interface must be managed by regular replacement, every few years, of the critical link located at the point of termination in the chain stopper. The reason for this is the bearings have a static friction component which resists motion and so causes bending fatigue in the chain links. It is typical that the small angle movements, which occur with the highest frequency contribute the most fatigue damage to the chain links. This is because at the small angle motions, typical of low seastates, the bearing friction is not overcome and the fairlead behaves as if it is rigidly fixed causing relatively high cyclical stresses in the chain.

It is evident to one skilled in the art of designing such structures that riser systems have largely utilised flex elements and mooring lines have used bearings to manage this critical interface. The flex element uses the low shear stiffness of rubber and the bearing uses low friction to achieve the desired response.

It is an aim of the present invention to overcome at least one problem associated with the prior art whether referred to herein or otherwise.

### SUMMARY OF THE INVENTION

According to a first aspect of the present invention there is provided a securement assembly comprising:
a pin;
a securement body;
an anchor structure; and
an axially loaded member, wherein the axially loaded member is rotatably secured to the anchor structure by securement of the pin in the securement body, and wherein the pin is retained within a bearing assembly located in the securement body, the bearing assembly comprising:
a resilient layer; and
a bearing surface on which an articulating surface is arranged to move over to enable relative rotation between the pin and the body,
wherein initial rotation of the pin relative to the body causes deformation of the resilient layer with an internal surface of the resilient layer rotating relative to an external surface of the resilient layer whilst the articulating surface remains static relative to the bearing surface and wherein further rotation of the pin relative to the body subsequently causes relative movement of the articulating surface over the bearing surface.

Preferably the securement assembly comprises a subsea securement assembly.

According to a second aspect of the present invention there is provided a bearing assembly for securing a pin to a body, the bearing assembly comprising:
a resilient layer; and
a bearing surface on which an articulating surface is arranged to move over to enable relative rotation between the pin and the body,
wherein initial rotation of the pin relative to the body causes deformation of the resilient layer with an internal surface of the resilient layer rotating relative to an external surface of the resilient layer whilst the articulating surface remains static relative to the bearing surface and wherein further rotation of the pin relative to the body subsequently causes relative movement of the articulating surface over the bearing surface.

Preferably the rotation of the pin relative to the body comprise two distinct stages wherein in the first (initial) stage the resilient layer deforms to cause the pin to rotate in the body and in the second (subsequent) stage the articulating surface is arranged to rotate relative to the bearing surface to cause the pin to rotate relative to the body.

Preferably the first stage causes the resilient layer to be configured in a deformed state with the external surface rotated relative to the internal surface and this deformed state is maintained during the second rotation stage.

Preferably the pin comprises a cylindrical pin.

Preferably the resilient layer comprises a cylindrical resilient layer.

Preferably the bearing surface provides a cylindrical bearing surface and the articulating surface may provide a cylindrical articulating surface.

Preferably the pin is coaxially retained within the body.

The outer surface of the pin may provide the articulating surface.

The pin may be retained centrally by a bearing assembly located in a link member.

The pin may be retained towards each longitudinal end by a housing which may comprise a first lateral bracket and a second lateral bracket. The housing may be located on the anchor structure. Each bracket may comprise a restraining element or plate to prevent relative rotation of the pin within the brackets.

The pin may be retained centrally by a link member which may be located between a first pin and a second pin. The pin may be retained centrally by a bearing assembly located in the link member. The link member may retain a central portion of a first pin and a central portion of a second pin.

The pin may be retained centrally by an end member provided on the end of the axially loaded member. The end member may comprise an eyelet. The pin may be retained centrally by a bearing assembly located in the end member.

Preferably the pin is retained to rotate about a single rotational axis and wherein this rotational axis may locate along the central longitudinal axis of the pin.

The pin may be retained towards each longitudinal end by a tether terminal member which may comprise a first lateral bracket and a second lateral bracket. Each bracket may comprise a restraining element or plate to prevent relative rotation of the pin within the brackets.

The pin may be retained towards each longitudinal end by a link member which may comprise a first lateral bracket and a second lateral bracket. Each bracket may comprise a restraining element or plate to prevent relative rotation of the pin within the brackets.

The subsea assembly may comprise a first pin and a second pin.

Preferably the first pin is retained by a first bearing assembly. The first pin may be retained by a central bearing assembly.

Preferably the second pin is retained by a second bearing assembly. The second pin may be retained by a central bearing assembly.

The subsea assembly may comprise link member. The link member may comprise an H-link member.

The subsea assembly may comprise a first pin retained at 90 degrees to a second pin. The rotational axis of the first pin may be positioned at 90 degrees to the rotational axis of the second pin.

The bearing assembly may comprise a cylindrical bearing component, a cylindrical resilient component and, in which the bearing component and the resilient component are coaxially arranged with the central pin. Preferably the bearing component and the resilient component are coaxially arranged within a cylindrical housing which may be provided by the anchor assembly and/or the tether assembly.

Preferably the bearing component is located coaxially within the cylindrical resilient component.

The cylindrical resilient component may be located coaxially within the bearing component.

The bearing component may be separated from the resilient component by an intermediary component which may comprise rigid (metal) cylindrical component.

The bearing component may provide an inner bearing surface.

The outer surface of the pin may provide the articulating surface.

The outer surface of an intermediary component may provide the articulating surface.

The bearing surface may be provided on a sleeve component.

The articulating surface may be provided on a sleeve component.

The resilient layer may comprise a resilient sleeve component.

Accordingly the present invention may provide a method for reliably supporting and terminating mooring lines connected to offshore floating vessels and submerged structures whereby a means of articulation at the point of the support of the tether will provide improved fatigue performance of the structure and mooring lines.

The invention may provide a method of terminating an axially loaded mooring tether in a highly compliant arrangement that greatly reduces the cyclic bending stresses in the adjacent components. Preferably the invention utilises a combination of cylindrical bearing surfaces and elastomeric interfaces to manage the structural response of the tether. The bearings may allow large angular fluctuations in the tether to accommodate gross variations with respect to the vessel. The elastomeric interfaces may provide a low rotational stiffness to manage the tether and structural stresses during the high cycle small seastate motions where the bearing may be working in a regime below its slip thresh hold and may be effectively stuck.

Preferably the invention allows the tether to rotate about all three axes by virtue of the combination of perpendicular cylindrical sliding bearings and elastomeric interfaces.

In this manner, a flexible connection between the tether and support structure may be made, which may support the full axial load of the mooring line while accommodating small angle low stiffness motions with the cylindrical elastomer elements and large angle motions with the cylindrical bearings.

According to a third aspect of the resent invention there is provided a method of rotatably securing an axially loaded member to an anchor structure, the method comprising securing the axially loaded member to the anchor structure through securement of a pin which is retained within a bearing assembly located within a securement body, and wherein, the bearing assembly comprises:
a resilient layer; and
a bearing surface on which an articulating surface is arranged to move over to enable relative rotation between the pin and the body,
the method comprising deforming the resilient layer through the initial rotation of the pin relative to the securement body with an internal surface of the resilient layer rotating relative to an external surface of the resilient layer whilst the articulating surface remains static relative to the bearing surface and the method further comprising subsequently causing the articulating surface to move relative to the bearing surface due to further rotation of the pin relative to the body.

### BRIEF DESCRIPTION OF THE DRAWINGS

The invention will now be further described, by way of example only, and with reference to the accompanying drawings, in which:

FIG. 1 is a perspective view of a tether connection;

FIG. 2 is a cross section through a preferred embodiment of a bearing assembly;

FIG. 3 is a cross section through an alternative embodiment of a bearing assembly;

FIG. 4 is a perspective view of part of a tether subsea securement assembly in accordance with the present invention;

FIG. 5a is a schematic view of an embodiment of a bearing assembly in an initial position;

FIG. 5b is a schematic view of an embodiment of a bearing assembly following a first stage of relative movement between a pin and an anchor assembly; and

FIG. 5c is a schematic view of an embodiment of a bearing assembly following a second stage of relative movement between a pin and an anchor assembly.

### DESCRIPTION OF THE PREFERRED EMBODIMENTS

The present invention relates to a system used in the offshore renewables or oil and gas industries for providing articulation at the end of a mooring line or a riser. The design uses a nested rubber segment and orthogonal cylindrical bearings to provide articulation with low resistance at both small and large oscillation angles. In particular, the present invention provides a compliant bearing.

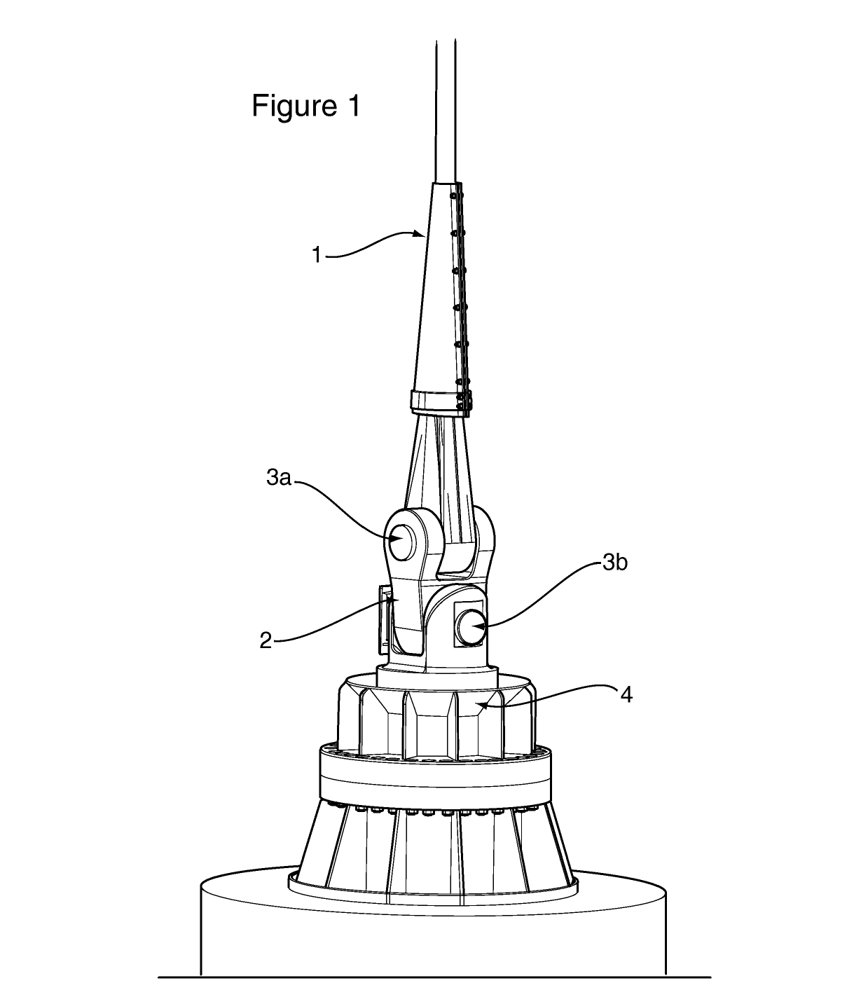

FIG. 1 shows a general arrangement of a typical mooring tether connection that would be compatible with this invention. The tether 1, is connected to a seabed foundation pile 4 via an H-link 2 and two pins 3a and 3b oriented 90 degrees to each other. The compliant bearings 10 surround the pins 3a and 3b and thereby provide a range of motion in multiple directions.

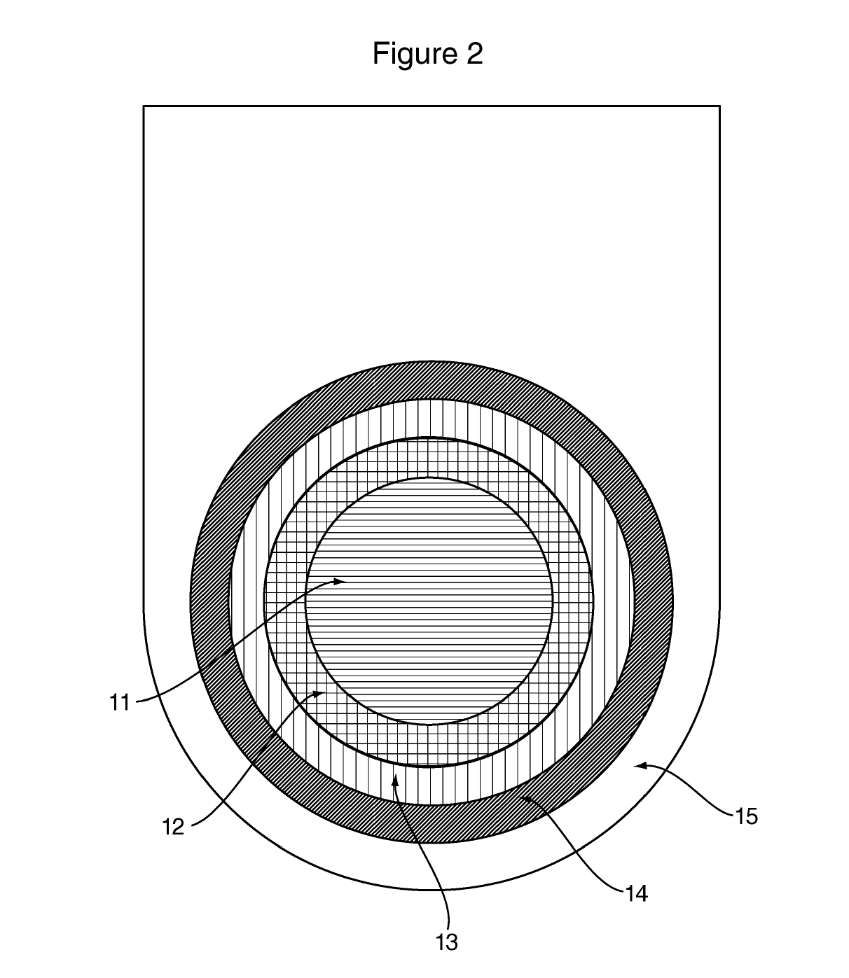

FIG. 2 shows a cross section view of a compliant bearing 10. The invention is designed for absorbing small oscillations about all axes with the rubber (elastomeric) element, and large oscillations about all axes with the cylindrical bearing.

A central pin 11 (a clevis pin) of metallic material transmits the load to the connected tether 1 or structure. The outer face of the pin 11 contacts a cylindrical bearing 12, which is in turn surrounded by a metallic (intermediary) cylinder 13. A cylindrical rubber (elastomeric/resilient) element 14 is bonded to the metallic cylinder 13 on the inside and also to a metallic housing 15 on the outside. The metallic housing 15 transmits the load to an adjacent assembly rotated at an angle to the pin 11 in order to give freedom of movement in orthogonal planes. The pin 11 in the adjacent assembly is connected to the outboard tether or structure.

The rubber segment 14 can be interspersed with thin metallic elements bonded to the rubber to increase the shear capacity. It can also be bonded to the external surfaces 13 and 15 to reduce wear and retain the fabricated geometry.

The rubber sleeve may be bonded on the inside surface and the outside surface. Additionally, the assembly may include a (metal) stop that limits the maximum rotation of the rubber to prevent damage to the rubber in extreme loading and in order to guarantee rotation of the bearing.

The rubber segment 14 may be constructed as a single cylindrical element or assembled from a series of separate rubber elements distributed between the cylindrical surfaces of elements 13 and 15. In both instances the rubber elements may consist of solid rubber or include a series of holes moulded or machined radially with respect to the cylindrical surface to modify the rubber response to load.

This may provide a laminated structure for the rubber cylinder and this utilises standard methods of construction for such components.

The rubber element 14 is protected from over stress by limiting the relative displacement of the internal cylinder 13 and external housing 15.

The bearing 12 may be constructed from a composite or metallic material, and may contain PTFE or graphite to manage the coefficient of friction and wear performance of the bearing. The thickness of the bearing pads is a function of the wear rate and required bearing life.

The bearing may be bonded to an outer element/sleeve on the outside surface but in some embodiments the bearing sleeve may not require this.

In use, a relative rotational force applied between the axially loaded member and the anchor assembly is arranged to cause the angle of the tether to change to reduce such forces. This movement is arranged to be provided by the securement assembly comprising one or more bearing assemblies 10. In particular, a first bearing assembly is arranged to provide rotation about a first axis and a second bearing assembly is arranged to provide rotation about a second axis. The first axis is arranged at 90 degrees to the second axis to provide rotation about two orthogonal axes. This is arranged to compensate for the movement of the floating offshore structure to which the tether is attached.

The bearing assembly is arranged to provide two distinct stages for relative rotation. In the first stage, small relative rotations are accommodated by the flexion or deformation in the rubber cylindrical layer 14. In particular, the outer surface of the rubber layer 14 is arranged to rotate about the central axis of the pin 11 relative to the inner surface of the rubber layer 14. Accordingly, this deformation or flexion of the rubber layer enables the tether to rotate around the pin and move relative to the anchor assembly. In the second stage, the further and subsequent movement of the tether causes an articulating surface to (physically slide) move over the bearing surface.

In the embodiment shown in FIG. 2, the outer cylindrical surface of the pin 11 is arranged to rotate within and over the inner cylindrical surface of the bearing layer 12. Accordingly, the outer cylindrical surface of the pin 11 provides the articulating surface to slide within the bearing surface.

The bearing assembly 10 provides a coaxial arrangement of sleeves in which the pin 11 is central and this is surrounded by a bearing sleeve 12 which is surrounded by an intermediary/metal sleeve 13 which is surrounded by a rubber/deformable sleeve 14 which is surrounded by the housing 15.

The bearing 12 and elastomeric element 14 may be located in alternate positions to suit the application. Multiple assemblies in various planes may be used to improve the wear and fatigue life of the structure and tether.

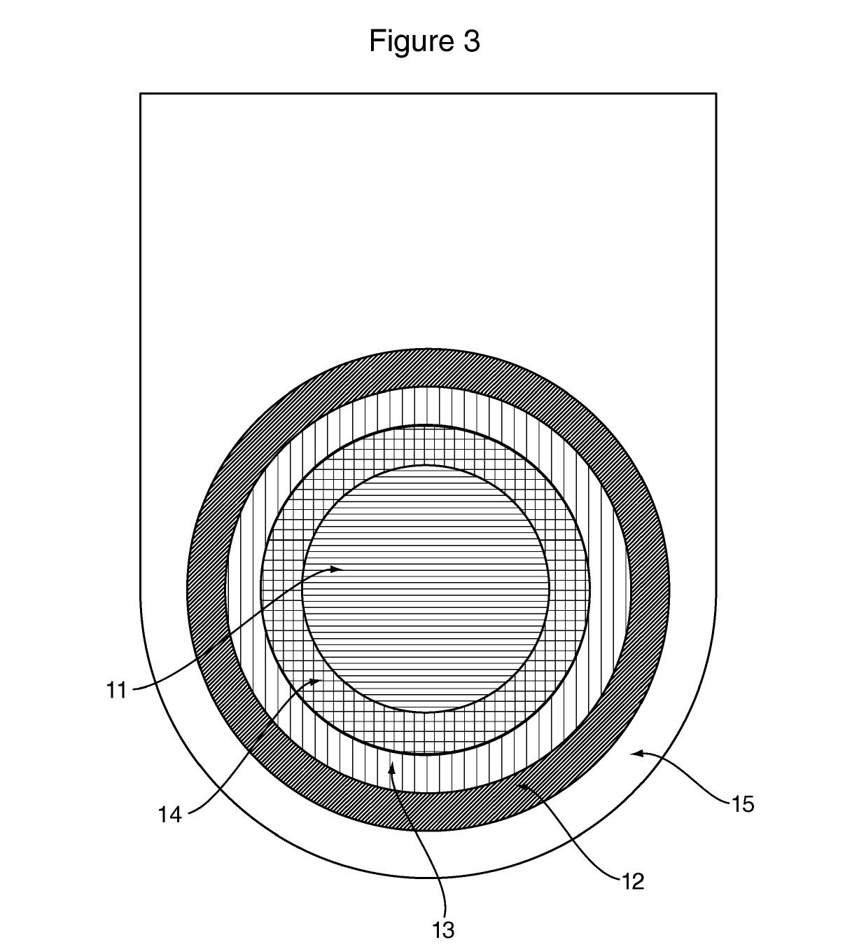

An alternative embodiment is shown in FIG. 3. In this embodiment the order of the different cylindrical layers has been altered compared to the embodiment shown in FIG. 2. Specifically the bearing layer 12 has switched position with the rubber layer 14. Accordingly, in this embodiment the rubber layer 14 is still arranged to initial deform to enable the first stage of movement. In the second stage, the outer surface of the metal cylindrical portion 13 is arranged to provide the articulating surface. This surface then rotates and slides relative to the inner cylindrical surface of the bearing layer 12 to create the second stage of motion.

In this embodiment, the bearing assembly 10 provides a coaxial arrangement of sleeves in which the pin 11 is central and this is surrounded by a rubber/resilient sleeve 14 which is surrounded by an intermediary/metal sleeve 13 which is surrounded by a bearing sleeve 12 which is surrounded by the housing 15.

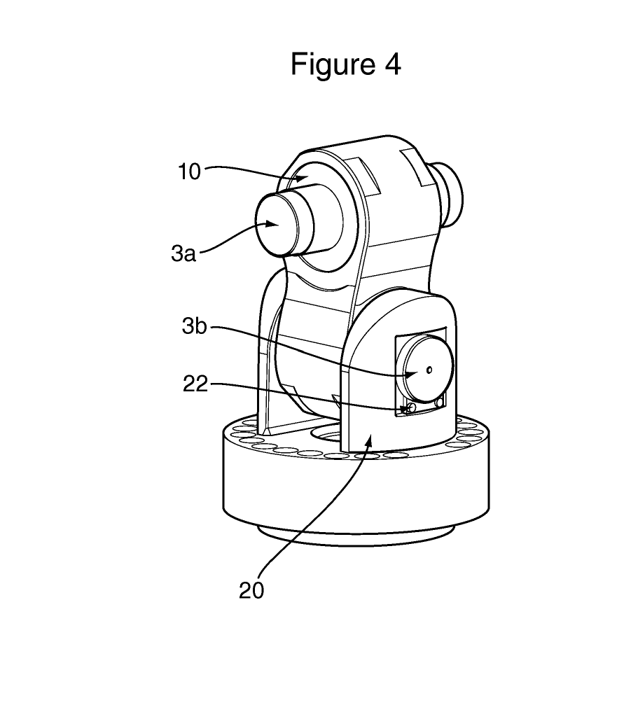

As shown in FIG. 4, the pins 3a, 3b are rotationally restrained in relation to either the H-link member or the external securement members provided by the anchor assembly 4 and the tether 1. It is just the central section of the pin(s) 3a, 3b that is rotationally restrained within the bearing assembly 10 of the present invention. The pins 3a, 3b are retained at or towards the ends by plate restraining elements in the form of plate components 22. These plate components locate within the supporting brackets 20 of the anchor assembly and/or in the supporting brackets provided by the tether.

As explained above, the pins 3a, 3b are rotationally restrained in relation to either the H-link 2 or the outboard items 1, 4. This is advantageous since in an arrangement with three bearings in a row, then it is possible that the inside one or outside pair may rotate preferentially, so there's not an even wear distribution. The bearings can only handle about 10% contact stress as the steel, so it's easier to make one component big and the other two components small.

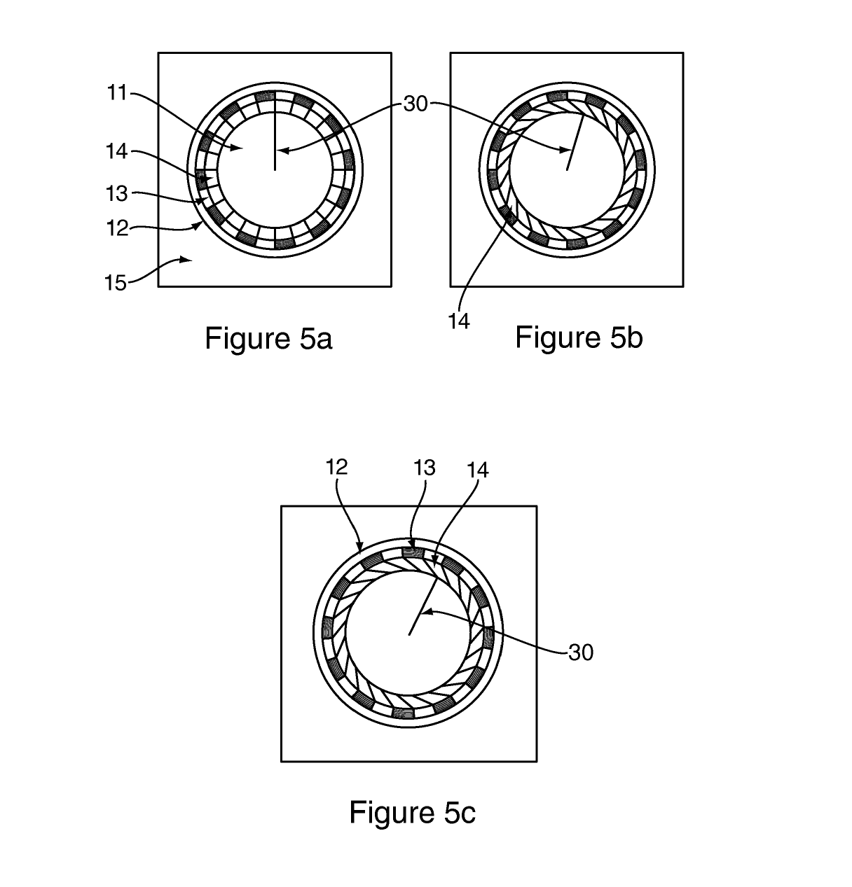

FIG. 5a, FIG. 5b and FIG. 5c show a schematic representation of the movements enables by the bearing assembly and the two different stages created by the bearing assembly.

From these schematic diagrams, it can be seen that the cylindrical rubber element is distorted between the initial position (FIG. 5a) and the second position (FIG. 5b) to allow for a restricted amount of rotation without any bearing components actually moving relative to each other. These figures include a reference line 30 to demonstrate the movement of the pin 11. In the second subsequent movement stage, where further rotation occurs, the metal cylindrical component 13 rotates within the bearing 12 as shown in FIG. 5c. During this second stage the distortion in the rubber layer 14 or elastomeric layer 14 is maintained.

The present invention provides a compliant tether as described using a combination of cylindrical bearing surfaces and cylindrical elastomeric flex elements to achieve a combination of low rotational stiffness and large angle deflection.

The present invention may be used for mooring floating offshore wind turbines. In addition, the present invention may be used for the mooring of floating oil and gas facilities, including compliant riser towers.

1. A securement assembly comprising:
a pin;
a securement body;
an anchor structure; and
an axially loaded member, wherein the axially loaded member is rotatably secured to the anchor structure by securement of the pin in the securement body, and wherein the pin is retained within a bearing assembly located in the securement body, the bearing assembly comprising:
a resilient layer; and
a bearing surface on which an articulating surface is arranged to move over to enable relative rotation between the pin and the body,
wherein initial rotation of the pin relative to the body causes deformation of the resilient layer with an internal surface of the resilient layer rotating relative to an external surface of the resilient layer whilst the articulating surface remains static relative to the bearing surface and wherein further rotation of the pin relative to the body subsequently causes relative movement of the articulating surface over the bearing surface.

2. A securement assembly according to claim 1 in which the rotation of the pin relative to the body comprise two distinct stages wherein in the first (initial) stage the resilient layer deforms to cause the pin to rotate in the body and in the second (subsequent) stage the articulating surface is arranged to rotate relative to the bearing surface to cause the pin to rotate relative to the body.

3. A securement assembly according to claim 2 in which the first stage causes the resilient layer to be configured in a deformed state with the external surface rotated relative to the internal surface and this deformed state is maintained during the second rotation stage.

4. A securement assembly according to claim 1 in which the bearing surface provides a cylindrical bearing surface and the articulating surface provides a cylindrical articulating surface.

5. A securement assembly according to claim 1 in which the pin is retained towards each longitudinal end by a housing which comprises a first lateral bracket and a second lateral bracket and wherein the housing is located on the anchor structure and each bracket comprises a restraining element to prevent relative rotation of the pin within the brackets.

6. A securement assembly according to claim 1 in which the pin is retained centrally by a link member which is located between a first pin and a second pin and in which the pin is retained centrally by a bearing assembly located in the link member and wherein the link member retains a central portion of the first pin and a central portion of the second pin.

7. A securement assembly according to claim 1 in which the pin is retained centrally by an end member provided on the end of the axially loaded member and in which the end member comprises an eyelet and wherein the pin is retained centrally by a bearing assembly located in the end member.

8. A securement assembly according to claim 1 in which the pin is retained to rotate about a single rotational axis and wherein this rotational axis locates along the central longitudinal axis of the pin.

9. A securement assembly according to claim 1 in which the pin is retained towards each longitudinal end by a tether terminal member which comprises a first lateral bracket and a second lateral bracket and wherein each bracket comprises a restraining element to prevent relative rotation of the pin within the brackets.

10. A securement assembly according to claim 1 in which the securement assembly comprises a subsea securement assembly.

11. A securement assembly according to claim 10 in which the subsea assembly comprises a first pin and a second pin, the first pin is retained by a first bearing assembly and in which the first pin is retained by a central bearing assembly and wherein the second pin is retained by a second bearing assembly and in which the second pin is retained by a central bearing assembly.

12. A securement assembly according to claim 10 in which the subsea assembly comprises a link member and wherein the link member comprises an H-link member.

13. A securement assembly according to claim 10 in which the subsea assembly comprises a first pin retained at 90 degrees to a second pin and in which the rotational axis of the first pin is positioned at 90 degrees to the rotational axis of the second pin.

14. A securement assembly according to claim 1 in which the bearing assembly comprise a cylindrical bearing component, a cylindrical resilient component and, in which the bearing component and the resilient component are coaxially arranged with the central pin and in which the bearing component and the resilient component are coaxially arranged within a cylindrical housing which is provided by an anchor assembly and/or a tether assembly and wherein the bearing component is separated from the resilient component by an intermediary component which comprise a rigid cylindrical component.

15. A bearing assembly for securing a pin to a body, the bearing assembly comprising:
a resilient layer; and
a bearing surface on which an articulating surface is arranged to move over to enable relative rotation between the pin and the body,
wherein initial rotation of the pin relative to the body causes deformation of the resilient layer with an internal surface of the resilient layer rotating relative to an external surface of the resilient layer whilst the articulating surface remains static relative to the bearing surface and wherein further rotation of the pin relative to the body subsequently causes relative movement of the articulating surface over the bearing surface.

16. A method of rotatably securing an axially loaded member to an anchor structure, the method comprising securing the axially loaded member to the anchor structure through securement of a pin which is retained within a bearing assembly located within a securement body, and wherein, the bearing assembly comprises:
a resilient layer; and
a bearing surface on which an articulating surface is arranged to move over to enable relative rotation between the pin and the body,
the method comprising deforming the resilient layer through the initial rotation of the pin relative to the securement body with an internal surface of the resilient layer rotating relative to an external surface of the resilient layer whilst the articulating surface remains static relative to the bearing surface and the method further comprising subsequently causing the articulating surface to move relative to the bearing surface due to further rotation of the pin relative to the body.

17-19. (canceled)
